(19) United States
(12) Patent Application Publication
(10) Pub. No.: US 2025/0017133 A1
(43) Pub. Date: Jan. 16, 2025

(54) PRESS WHEEL

(71) Applicant: RYAN NT INTERNATIONAL PTY LTD, Horsham (AU)

(72) Inventor: Paul Ryan, Horsham (AU)

(73) Assignee: RYAN NT INTERNATIONAL PTY LTD, Horsham (AU)

(21) Appl. No.: 18/773,955

(22) Filed: Jul. 16, 2024

(30) Foreign Application Priority Data
Jul. 16, 2023 (AU) 2023902274

(51) Int. Cl. A01C 5/06

(52) U.S. Cl. CPC A01C 5/068

(57) ABSTRACT

A press wheel may be configured for use on cultivation equipment and may include a base member configured to be mounted to an axle. The base member may comprise a plate portion and a rim portion; a resilient coil member mounted to the plate portion of the base member; and a guard member mounted to the base member. The resilient coil member may be configured to wind about the base member to define an outer periphery of the press wheel extending from the plate portion toward the rim portion of the base member. The guard member may at least partially extend between the plate portion and the rim portion of the base member. The guard member may be configured to extend under the resilient coil member.

### FIELD OF INVENTION

The present invention relates generally to agricultural devices, and in particular, to a press wheel for use in an agricultural device.

### BACKGROUND OF THE INVENTION

In agricultural equipment, such as seed drills, seeds are placed in a furrow formed in the soil to create a crop. The seed drill is typically driven by a tractor or similar device, where a disc or point forms a furrow in the soil and the seed is deposited into the furrow by a seeder unit. A press wheel typically trails the seeder unit to close the furrow and apply pressure to the soil to ensure that there is adequate contact of the seed with the soil.

The function of the press wheel is to pass over the surface of the soil to engage the sides of the furrow to close the furrow and cover the seed with soil. Conventional press wheels are made from a solid wheel with a rubber periphery that travels along the ground surface to close the furrow. A problem with such a conventional press wheel is that in some soil conditions, especially clay type soils, the rubber press wheel may compress the soil an excessive amount, resulting in the surface of the soil cracking or smearing, which can harden the soil around the seeds. This can have a significant negative effect on the growth of the seed and the crop potential.

Similarly, in no-till cropping applications, the ground surface into which the seeds are deposited typically has heavy crop residue and has not been prepared. As a result, a conventional rubber press wheel will tend to bounce along the unprepared ground surface and fail to adequately close the furrow and cover the seeds. This can have a considerable detrimental effect on the crop and the ability of the seeds to germinate and grow to an optimal level.

A variety of different types of press wheels have been developed to address this problem and to ensure adequate closing of the furrow after seeding. One such proposal has been to employ spiked closing wheels to replace traditional rubber wheels. The spiked closing wheels are able to penetrate the soil and crop residue thereby breaking up the soil in the process and avoiding bouncing of the closing wheel. However, such wheels have also been found to penetrate too deeply into the soil surface, especially in softer soil conditions, resulting in the seeds becoming displaced and requiring the operator to replace the spiked wheels during use. As a result, air pockets can be formed about the seeds and trench cracking can occur, which can result in uneven germination and inconsistent crop growth.

More recently, coil press wheels have been developed that employ a resilient coil member attached to a hub member and wound in a plurality of windings so as to substitute for a conventional tyre. This press wheel travels over the ground surface to close and compress the furrow and surrounding soil. Such coil press wheels have proven effective as they perform a squeezing action as they flex and travel over the ground surface, pressing any air pockets from the soil and providing good soil-seed contact. However, in particularly rough soil conditions, where there may be heavy stubble and uneven surface conditions, the coils may bounce and undergo deformation due to the forces present. This can cause damage to the coil wheel and can adversely affect its ability to properly function.

Further to this, in soil conditions that are wet and muddy, the coil wheel may sink into the soil and fail to perform their function due to the open nature of the coil. In some crops, such as corn, the stubble present with the wet soil may create sloppy conditions which cause the coil when to become buried in the soil, such that the wheel does not travel over the surface of the soil but is dragged through the soil, which is undesirable.

Thus, there is a need to provide for an improved press wheel that is capable of handling particularly rugged terrain and which protects the coil from damage during use and which can also handle wet and sloppy conditions.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### STATEMENT OF INVENTION

The invention according to one or more aspects is as defined in the independent claims. Some optional and/or preferred features of the invention are defined in the dependent claims.

Accordingly, in one aspect of the invention there is provided a press wheel for use on cultivation equipment comprising:
a base member configured to be mounted to an axle, the base member comprising a plate portion and a rim portion;
a resilient coil member mounted to the plate portion of the base member and configured to wind about the base member to define an outer periphery of the press wheel extending from the plate portion toward the rim portion of the base member; and
a guard member mounted to the base member so as to at least partially extend between the plate portion and the rim portion of the base member, the guard member being configured to extend under the resilient coil member.

The rim portion may be displaced laterally from the plate portion and the resilient coil member may extend laterally from the plate portion toward the rim portion.

The rim portion may be attached to the plate portion by one or more connector arms.

The guard member may have a substantially frustoconical configuration.

The guard member may be mounted to the rim portion of the base member. The guard member may comprise one or more recesses to accommodate the one or more connector arms when the guard member is mounted to the base member.

The guard member may be made from a polymeric material.

### BRIEF DESCRIPTION OF THE DRAWINGS

The invention may be better understood from the following non-limiting description of preferred embodiments, in which:

FIG. 1 is a perspective view of a press wheel in accordance with an embodiment of the present invention;

FIG. 2 is a front view of the press wheel of FIG. 1;

FIG. 3 is an end view of the press wheel of FIG. 1;

FIG. 4 is a side view of the press wheel of FIG. 1;

FIG. 5 is an exploded view of the press wheel of FIG. 1; and

FIGS. 6A-6C are perspective, top and side views of the guard member for use with the press wheel of FIG. 1.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention.

The present invention will be described below in relation to a press wheel or gauge wheel for use in a seed drill, or similar agricultural device for use in planting crops. However, it will be appreciated that the wheel of the present invention could also be used in a variety of other applications that require movement over a ground surface, and still fall within the spirit of the present invention.

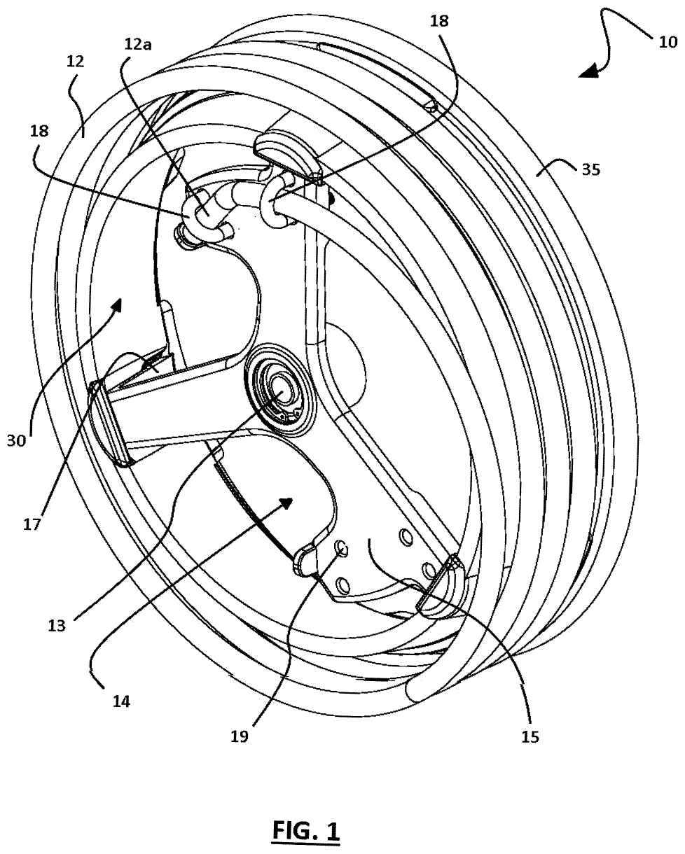

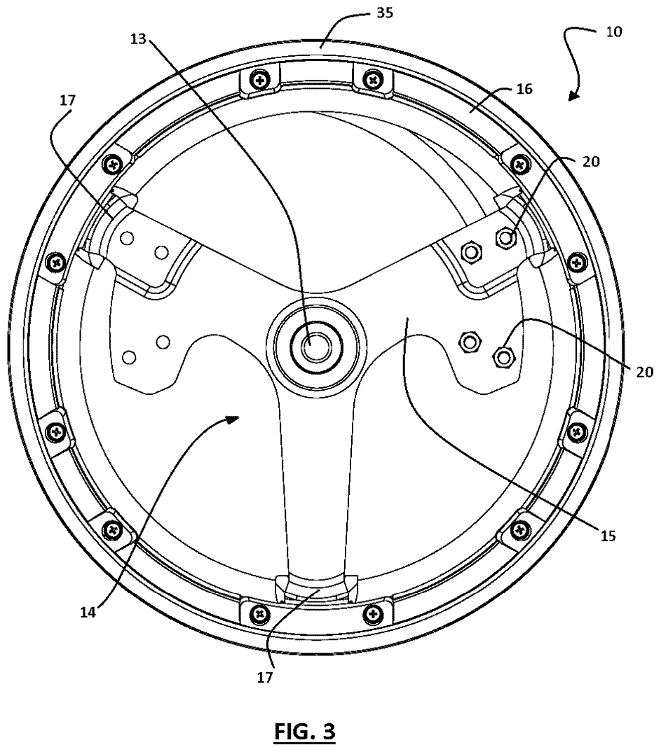

Referring to FIGS. 1-5, a press wheel 10, in accordance with an embodiment of the present invention, is depicted.

The press wheel 10 generally comprises a coil 12 wound in a helical manner to form a periphery of the wheel 10. The coil 12 is made from a spring steel, or similar material, and has a degree of resilience to retain shape during use. The coil 12 is wound in at least three windings to provide a substantially width over which the wheel 10 is supported during motion. It will be appreciated by those skilled in the art that the number of coil windings will vary, as will the space between the windings, depending upon the requirements of use.

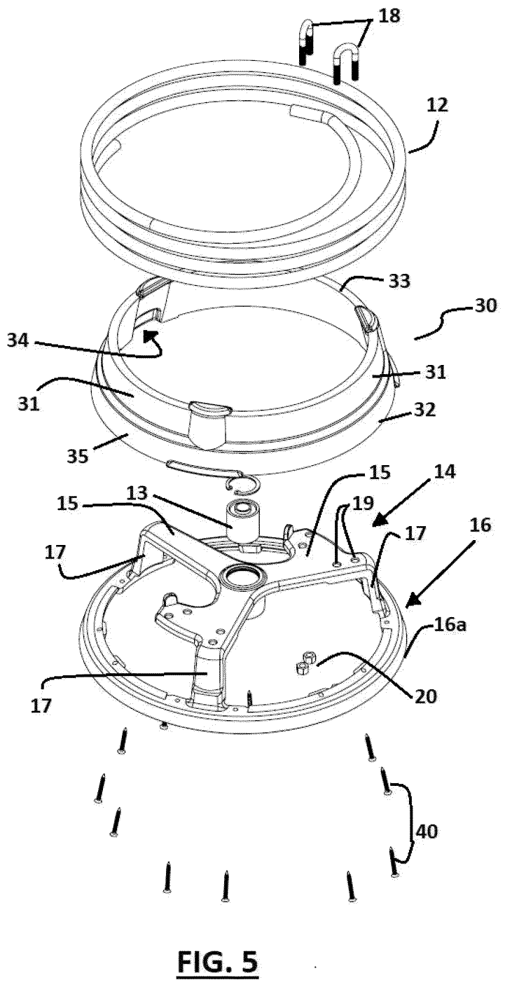

The coil 12 is mounted about a base member 14. As can be more clearly seen in FIG. 5, the base member 14 comprises a plate portion 15 and a rim portion 16 displaced laterally from the plate portion 15. The plate portion 15 is connected to the rim portion 16 by way of integrally formed connector arms 17, such that the plate portion and the rim portion form an integral unit. It will be appreciated that in an alternative embodiment the connector arms 17 may be separately formed and connected to the plate portion 15 and the rim portion 16 by way of connecting screws and the like. In the embodiment as depicted, the plate portion 15 is configured to form three spokes extending from a central hub 13 in a substantially planar manner, although the number of spokes formed by the plate portion may vary. The connector arms 17 extend from the spokes of the plate portion to connect to the rim portion 16, such that the rim portion 16 has a substantially circular configuration to define a peripheral rim 16a projecting about the base member 14.

The plate portion 15 has a central hub 13 formed therein to facilitate securing the base member 14 to an axle of a seeder unit or similar agricultural machinery. This arrangement enables the wheel 10 to receive motive force to rotate under the direction of a tractor or the like, that may be driving the seeder unit. The wheel 10 will rotate about the axis defined by the hub 13.

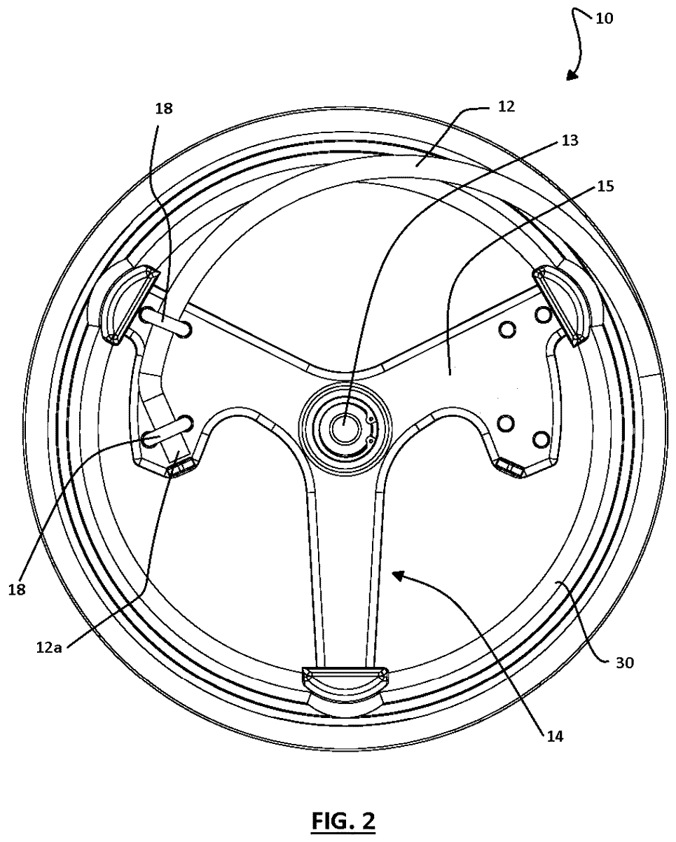

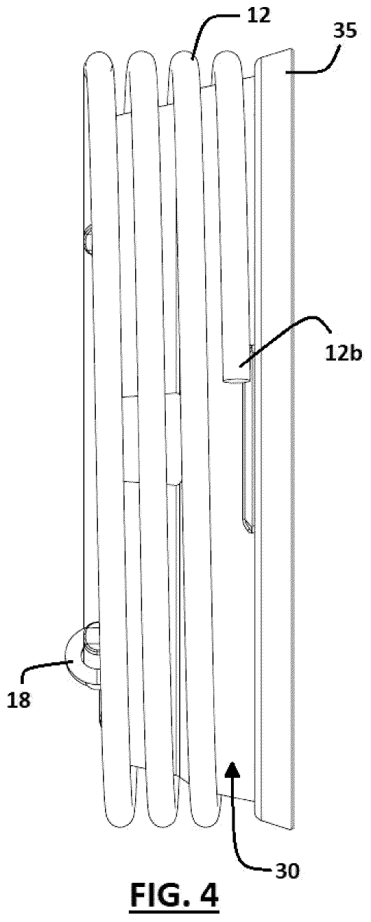

As is shown in FIG. 2, one end 12a of the coil 12 is mounted to the front surface of the plate portion 15 of base member 14. As is shown in FIG. 4, the other end 12b of the coil 12 is wound in a coiled manner to terminate adjacent the peripheral rim 16a of the rim portion 16. The end 12a is attached to the plate portion 15 of the base member 14 by U-bolts 18 that fit over the end 12a of the coil 12 and pass through holes 19 formed in the plate portion 15 to be secured in position by nuts 20. It will be appreciated that the manner in which the end 12a of the coil 12 attaches to the base member and the location at which the end 12a attached to the base member may also vary.

As can be seen more clearly in FIG. 4, the coil 12 forms a substantially cylindrical outer surface around the base member 14 with the rim portion 16 of the base member also defining the outer surface of the wheel 10. In this regard, in use, the coil 12 contacts the soil as the wheel 10 passes over the ground surface to rotate as it contacts the ground surface, thereby engaging the sides of a furrow, to close the furrow.

It will be appreciated that as the wheel 10 rotates over a ground surface, the coil 12 will bear the weight of the ground contact of the system. As the coil 12 is made from a resilient metal material, as the wheel 10 rotates it will flex to accommodate changes in the surface level of the ground surface. As the wheel 10 is intended to maintain contact with the ground surface to apply force to the soil and close the furrow, any bouncing of the wheel 10 during motion is to be avoided. However, with no-till farming methods becoming particularly more popular, it is common for the surface along which the wheel 10 will travel to contain stubble and other residue from previous crops, resulting in a ground surface that can be relatively uneven. It will be appreciated that in wet and muddy conditions, the surface may become sloppy and as the coil 12 has spaces between windings, the sloppy soil surface may pass into the spaces between the coil windings causing the wheel to sink into the soil surface. Such a situation is to be avoided as should the wheel become at least partially embedded in the soil surface, the wheel 10 may no longer rotate and may drag through the surface, becoming ineffective and having a potentially detrimental effect on the crop.

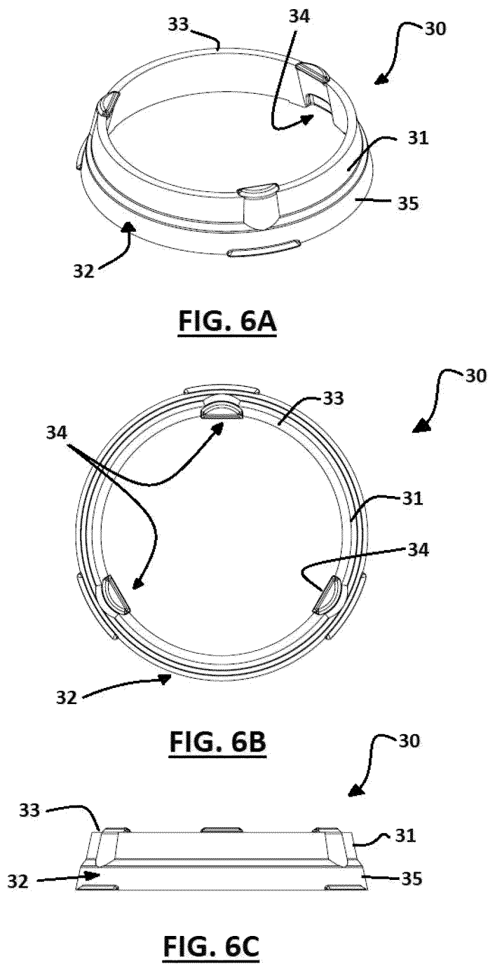

To address this problem, the present invention provides a guard member 30 as depicted in isolation in FIGS. 6A-6C. The guard member 30 has a substantially frustoconical shape with walls 31 that taper inwardly from a base 32 towards an upper end 33. The guard member 30 is preferably made from a plastic or polymeric material, such as nylon, that is a one-piece moulded unit, having improved durability and wear resistance. The inner surface of the walls 31 have recesses 34 formed therein to receive and locate over the connector arms 17 of the base member 14, as shown in FIG. 5. This aids in positioning the guard member 30 on the base member 14 for ease of mounting.

The base 32 of the guard member 30 has a peripheral ring portion 35 that fits over the peripheral rim 16a of the rim portion 16. The guard member 30 is then fixed in position to the base member 14 through screws 40 that pass through holes provided in the rim portion 16 which are then engaged with the guard member 30 to secure the guard member 30 in position, as depicted in FIG. 5. In such a position the walls 31 of the guard member 30 extend under the coil 12 toward the plate portion 15 of the base member 14, as is shown more clearly in FIG. 4.

When positioned in such a manner, the guard member 30 allows a small degree of penetration of soil and associated ground material through the gaps between the coil windings, but prevents the wheel 10 from sinking into the soil due to the limited penetration space provided under the coil. Thus, the wheel 10 is able to be maintained on a surface of the soil and rotate, even in the presence of sloppy soil conditions, which would otherwise penetrate into the coil windings and cause the wheel to sink into the soil.

As the guard member 30 is preferably formed from a nylon or plastic material, it has sufficient durability to withstand impact with the coil 12 during use. This enables the coil 12 to continue to flex and move as it passes over the surface of the soil and ensures that there is minimal damage to the coils, as may occur when the coils contact with the metal surfaces of the base member 14 in the absence of such a guard member. This improves the maintenance life of the wheel and ensures the integrity of the wheel is maintained during use.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the wheel uppermost.

It will be appreciated by those skilled in the art that many modifications and variations may be made to the methods of the invention described herein without departing from the spirit and scope of the invention.

1. A press wheel for use on cultivation equipment comprising:
a base member configured to be mounted to an axle, the base member comprising a plate portion and a rim portion;
a resilient coil member mounted to the plate portion of the base member and configured to wind about the base member to define an outer periphery of the press wheel extending from the plate portion toward the rim portion of the base member; and
a guard member mounted to the base member so as to at least partially extend between the plate portion and the rim portion of the base member, the guard member being configured to extend under the resilient coil member.

2. A press wheel according to claim 1, wherein the rim portion is displaced laterally from the plate portion and the resilient coil member extends laterally from the plate portion toward the rim portion.

3. A press wheel according to claim 2, wherein the rim portion is attached to the plate portion by one or more connector arms.

4. A press wheel according to claim 3, wherein the guard member has a substantially frustoconical configuration.

5. A press wheel according to claim 4, wherein the guard member is mounted to the rim portion of the base member.

6. A press wheel according to claim 5, wherein the guard member comprises one or more recesses to accommodate the one or more connector arms when the guard member is mounted to the base member.

7. A press wheel according to claim 1, wherein guard member is made from a polymeric material.
